(19) United States
(12) Patent Application Publication
(10) Pub. No.: US 2016/0108951 A1
(43) Pub. Date: Apr. 21, 2016

(54) NUT

(71) Applicant: Chia-Che HSU, KAOHSIUNG (TW)

(72) Inventor: Chia-Che HSU, KAOHSIUNG (TW)

(21) Appl. No.: 14/515,541

(22) Filed: Oct. 16, 2014

(51) Int. Cl. F16B 37/00

(52) U.S. Cl. CPC F16B 37/00

(57) ABSTRACT

A nut includes a body having a neck connected to one end thereof and the neck has a breaking portion formed on the first end thereof. The breaking portion is connected to the end of the body. The thickness of the breaking portion is smaller than that of the neck. A polygonal holding portion is formed to the second end of the neck. The body has a threaded hole defined axially therethrough and the holding portion has a through hole which communicating with the threaded hole. Once the body of the nut is locked to a bolt, the breaking portion is broken and only the body is mounted onto the bolt. The body has a smooth cylindrical outer face.

### BACKGROUND OF THE INVENTION

1. Fields of the Invention

The present invention relates to a nut, and more particularly, to a nut that cannot be removed from the bolt.

2. Descriptions of Related Art

The conventional nut 10 is disclosed in FIG. 1 and generally is a hexagonal nut 10 and a tool is able to clamp two sides of the hexagonal nut 10 and rotate it so as to lock the nut 10 to an object 12, or remove the nut 10 from the object 12. If the users want the nut 10 to be permanently locked to the object 12 and cannot be removed, at least one welding spot 13 is applied to the connection portion between the nut 10 and the bolt 11 as shown in FIG. 1, However, it takes a lot of time to weld the nut 10 to the bolt 11 and this also increases the cost.

The present invention intends to provide a nut that is designed not to be removed from the bolt so as to eliminate the shortcomings mentioned above.

### SUMMARY OF THE INVENTION

The present invention relates to a nut and comprises a body having a neck connected to one end thereof, and the neck has a breaking portion formed on the first end thereof. The breaking portion is connected to the end of the body. The thickness of the breaking portion is smaller than that of the neck. A polygonal holding portion is formed to the second end of the neck. The body has a threaded hole defined axially therethrough and the holding portion has a through hole which communicating with the threaded hole. Once the body of the nut is locked to a bolt, the breaking portion is broken and only the body is mounted onto the bolt.

Preferably, the body has a smooth cylindrical outer face.

Preferably, the body has a smooth tapered outer face.

The primary object of the present invention is to provide a nu that is easily mounted to a bolt and cannot be removed from the bolt.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the conventional nut is used to a bolt which extends through two objects;

FIG. 2 is a perspective view to show the first embodiment of the nut of the present invention;

FIG. 3 is a cross sectional view to show the first embodiment of the nut of the present invention;

FIG. 4 is a cross sectional view to show that the first embodiment of the nut of the present invention is mounted to a bolt wherein the holding portion and the neck are not yet separated from the body of the first embodiment of the nut;

FIG. 5 is a cross sectional view to show that the first embodiment of the nut of the present invention is mounted to a bolt wherein the holding portion and the neck are separated from the body of the first embodiment of nut;

FIG. 6 is a perspective view to show the second embodiment of the nut of the present invention;

FIG. 7 is a cross sectional view to show the second embodiment of the nut of the present invention;

FIG. 8 is a cross sectional view to show that the second embodiment of the nut of the present invention is mounted to a bolt wherein the holding portion and the neck are not yet separated from the body of the second embodiment of the nut, and

FIG. 9 is a cross sectional view to show that the second embodiment of the nut of the present invention is mounted to a bolt wherein the holding, portion and the neck are separated from the body of the second embodiment of nut.

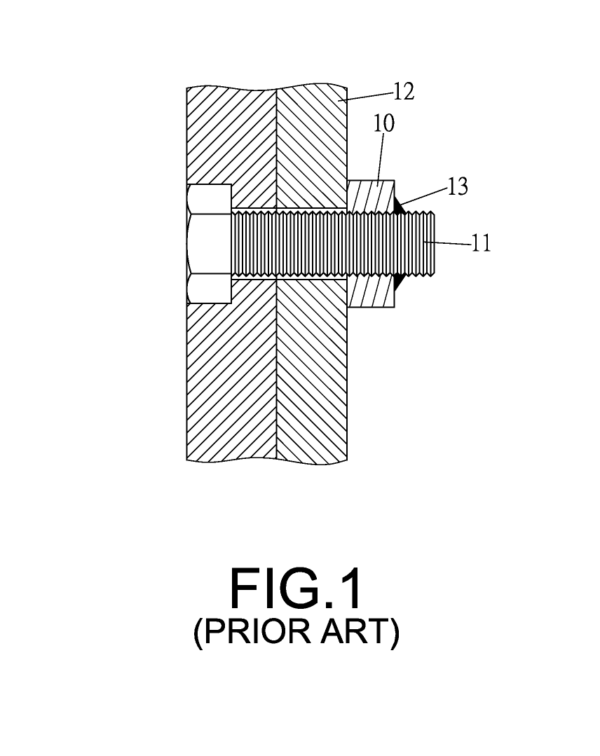

### DETAILED DESCRIPTION OF THE PREFERRED EMBODIMENT

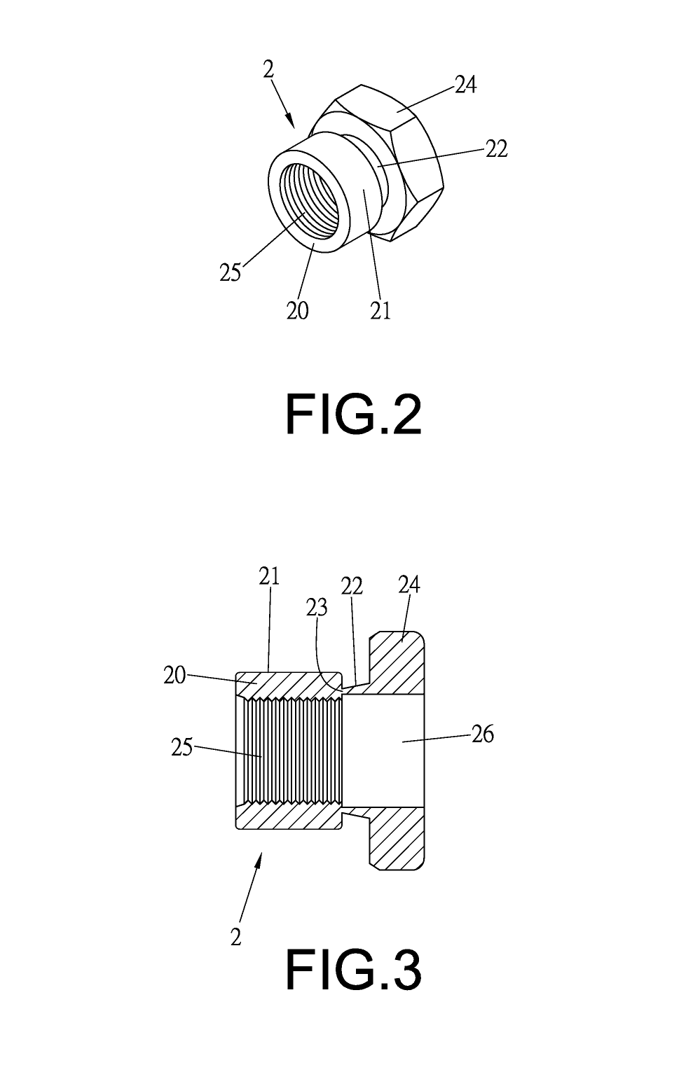

Referring to FIGS. 2 and 3, the nut 2 of the present invention comprises a tubular body 20 having a neck 22 connected to one end thereof. The neck 22 has a breaking portion 23 formed on the first end thereof, and a polygonal holding portion 24 is formed to the second end of the neck 22. The polygonal holding portion 24 is a hexagonal holding portion. The breaking portion 23 is connected to the end of the body 20. The thickness of the breaking portion 23 is smaller than that of the neck 22. The body 20 has a threaded hole 25 defined axially therethrough. The holding portion 24 has a through hole 26 which communicating with the threaded hole 25.

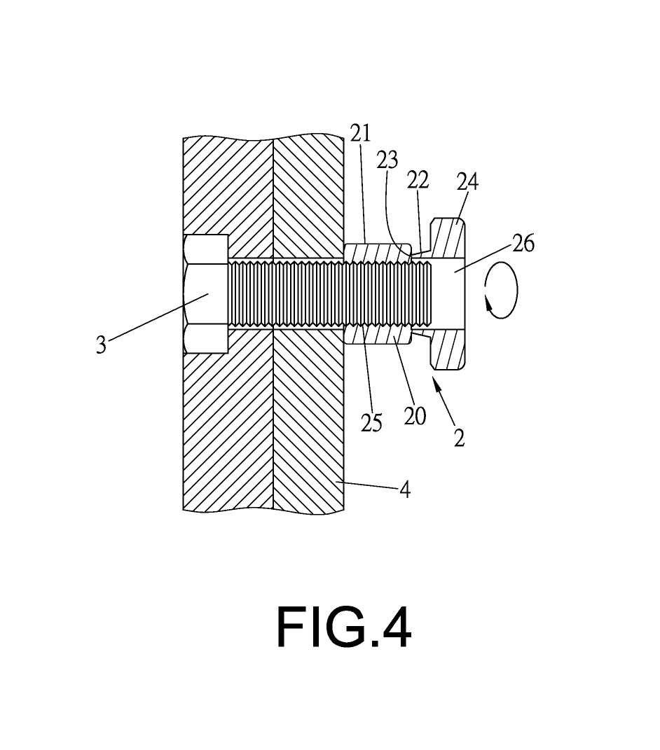

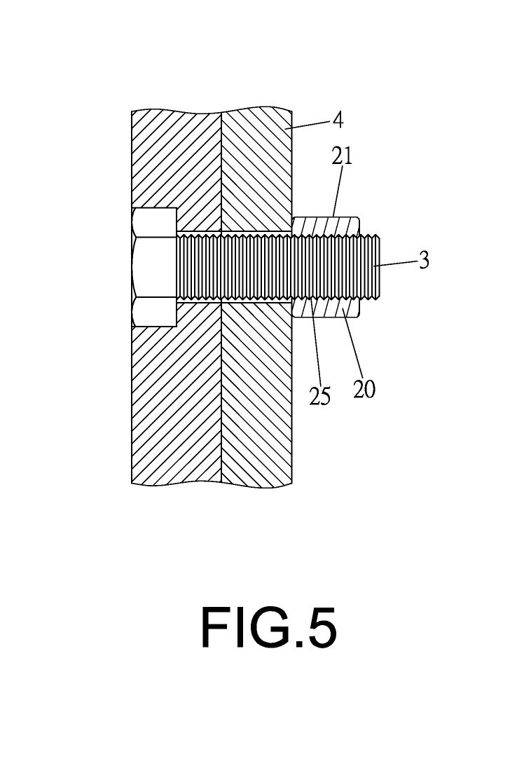

When in use, as shown in FIGS. 4 and 5, a bolt 3 extends through an object 4 and the threaded section of the bolt 3 extends beyond the object 4. The nut 2 is mounted to the threaded section of the bolt 3 and the nut 2 is rotated by using a tool holding the holding portion 24. The threaded section of the bolt 3 is threadedly connected to the threaded hole 25 of the body 20 of the nut 2 when rotating the nut 2. When the nut 2 securely contacts against the object 4, the tool is continuously rotated, the torque applied to the holding portion 24 breaks the breaking portion 23 because the thickness of the breaking portion 23 is thinner than the rest portion of the neck 22 as shown in FIG. 5. The holding portion 24 and the neck 22 are then removed from the body 20 and the threaded section of the bolt 3. Because the body 20 has a smooth cylindrical outer face 21 so that no tool can clamp the body 20 to remove the body 20 from the bolt 3.

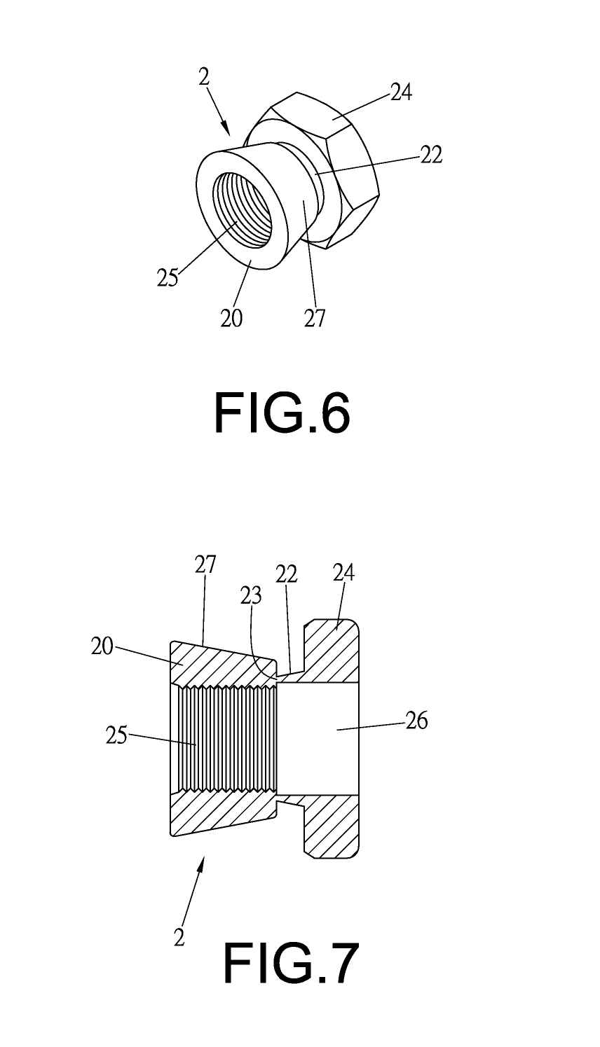

FIGS. 6 and 7 show the second embodiment of the present invention, wherein the difference between the first embodiment and the second embodiment of the present invention is that the body 20 has a smooth tapered outer face 27.

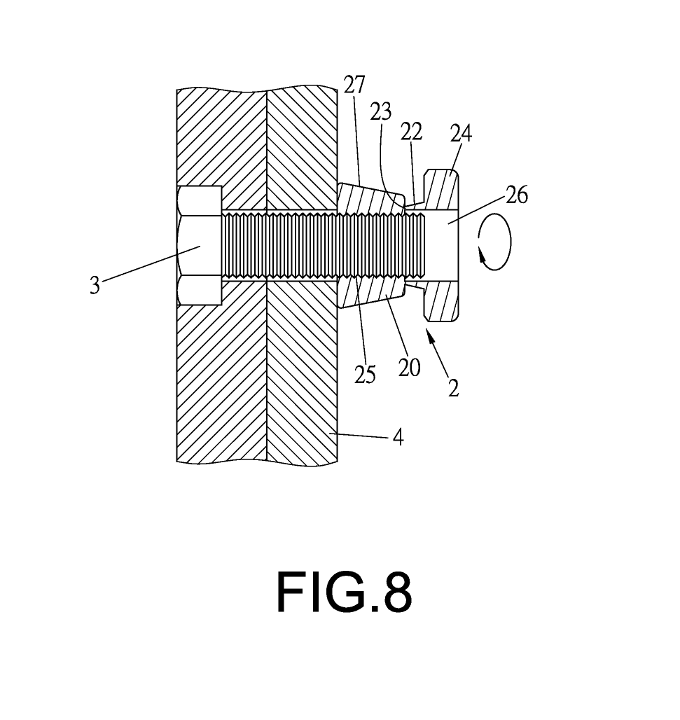

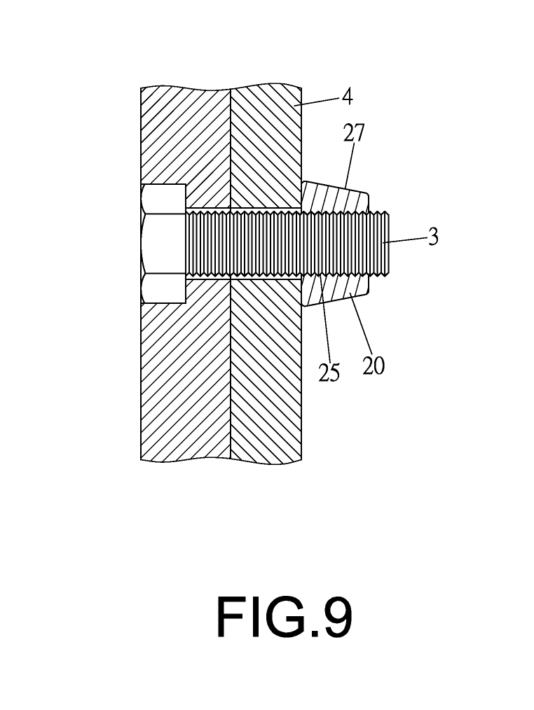

Similarly, when in use, as shown in FIGS. 8 and 9, a bolt 3 extends through an object 4 and the threaded section of the bolt 3 extends beyond the object 4. The nut 2 is mounted to the threaded section of the bolt 3 and the nut 2 is rotated by using a tool holding the holding portion 24. The threaded section of the bolt 3 is threadedly connected to the threaded hole 25 of the body 20 of the nut 2 when rotating the nut 2. When the nut 2 securely contacts against the object 4, the tool is continuously rotated, the torque applied to the holding portion 24 breaks the breaking portion 23 because the thickness of the breaking portion 23 is thinner than the rest portion of the neck 22 as shown in Fig. 7. The holding portion 24 and the neck 22 are then removed from the body 20 and the threaded section of the bolt 3. Because the body 20 has a smooth tapered outer face 27 so that no tool can clamp the body 20 to remove the body 20 from the bolt 3.

While we have shown and described the embodiment in accordance with the present invention, it should be clear to those skilled in the art that further embodiments may be made without departing from the scope of the present invention.

What is claimed is:

1. A nut comprising:
a body having a neck connected to an end thereof, the neck having a breaking portion formed on a first end thereof, the breaking portion connected to the end of the body, a thickness of the breaking portion being smaller than that of the neck, a polygonal holding portion formed to a second end of the neck, the body having a threaded hole defined axially therethrough, the holding portion having a through hole which communicating with the threaded hole.

2. The nut as claimed in claim 1, wherein the body has a smooth cylindrical outer face.

3. The nut as claimed in claim 1, wherein the body has a smooth tapered outer face.
